(19) United States
(12) Patent Application Publication
(10) Pub. No.: US 2026/0332534 A1
(43) Pub. Date: Oct. 22, 2026

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yuxin MAO, Beijing (CN)

(73) Assignee: Beijing Xiaomi Mobile Software Co., Ltd., Beijing (CN)

(21) Appl. No.: 19/112,159

(22) PCT Filed: Sep. 16, 2022
(86) PCT No.: PCT/CN2022/119477

§ 371 Date: Mar. 14, 2025

(51) Int. Cl. H04L 47/32; H04L 67/131; H04W 8/24

(52) U.S. Cl. CPC H04L 47/32; H04L 67/131; H04W 8/24

(57) ABSTRACT

A method, computer readable medium and system for information processing in a wireless communication network are disclosed. A user equipment (UE) transmits capability information to an access network function node, indicating whether it supports transfer optimization or initiative selective packet discarding by a user plane function (UPF) on service data. The capability information may be sent via registration request, registration update, or UE configuration update messages. The service data may include extended reality and media (XRM) or multimodal service data. The disclosed method further includes processing by a policy control function (PCF) or session management function (SMF), which receives the UE capability information, generates policy rules, and transmits rule information to the UPF. The UPF receives and processes the rule information to optimize data transfer or selectively discard packets based on network conditions, predictive analytics, or notifications from network functions.

### CROSS-REFERENCE TO RELATED APPLICATIONS

This application is a national stage of International Application No. PCT/CN2022/119477, filed on Sep. 16, 2022, which is hereby incorporated by reference in its entirety.

### TECHNICAL FIELD

The present disclosure relates to but is not limited to, the field of communication technologies, and in particular, to an information processing method and apparatus, a communication device, and a storage medium.

### BACKGROUND

Mobile media services, extended reality (XR) services such as augmented reality (AR) services or virtual reality (VR) services, cloud game services, video-based robots or unmanned aerial vehicle remote control services are expected to contribute an increasing amount of traffic to networks.

In addition to audio and video flows, XR services involve multimodal data flows, such as biotactile data flows.

These multimodal data represents data of a service or application input from the same device or different devices (which include sensors), and these data may be output to one or more destination device terminals.

Each data flow in the multimodal data usually has a certain or even strong correlation, for example, synchronization between an audio flow and a video flow, and synchronization between haptic and visual.

The data flows of such media services, among the data flows, and the requirements of these service data flows for network transmission all have some common features; effective identification and utilization of these features will be more conducive to the transmission and control of networks and services, and also to the service guarantee and user experience.

### SUMMARY

Embodiments of the present disclosure provide an information processing method and apparatus, a communication device and a storage medium.

A first aspect of the embodiments of the present disclosure provides an information processing method, performed by a user equipment (UE), the method including:
receiving UE capability information sent by an access network function node;
where the UE capability information indicates whether the UE supports transfer optimization or initiative selective packet discarding performed by a user plane function (UPF) on service data of the UE.

A second aspect of the embodiments of the present disclosure provides an information processing method, performed by an access network function node, the method including:
receiving UE capability information of a user equipment (UE), and
sending the UE capability information to an access management function (AMF) of the UE; where the UE capability information indicates whether the UE supports transfer optimization or initiative selective packet discarding performed by a user plane function (UPF) on service data of the UE.

A third aspect of the embodiments of the present disclosure provides an information processing method, performed by an AMF, the method including:
receiving user equipment (UE) capability information sent by an access network function node;
sending the UE capability information to a policy control function (PCF) or a session management function (SMF), where the UE capability information indicates whether a UE supports transfer optimization or initiative selective packet discarding performed by a user plane function (UPF) on service data of the UE.

A fourth aspect of the embodiments of the present disclosure provides an information processing method, performed by a policy control function (PCF) or a session management function (SMF), the method including:
receiving user equipment (UE) capability information provided by an access management function (AMF), where the UE capability information indicates whether a UE supports transfer optimization or initiative selective packet discarding performed by a user plane function (UPF) on service data of the UE.

A fifth aspect of the embodiments of the present disclosure provides an information processing method, performed by a UPF, the method including:
receiving rule information, where the rule information is generated according to UE capability information; where the UE capability information indicates whether a UE supports transfer optimization or initiative selective packet discarding performed by the UPF on service data of the UE.

A sixth aspect of the embodiments of the present disclosure provides an information processing apparatus, including:
a first sending module, configured to send user equipment (UE) capability information to an access network function node;
where the UE capability information indicates whether the UE supports transfer optimization or initiative selective packet discarding performed by a user plane function (UPF) on service data of the UE.

A seventh aspect of the embodiments of the present disclosure provides an information processing apparatus, including:
a first receiving module, configured to receive user equipment (UE) capability information of a UE;
a second sending module, configured to send the UE capability information to an access management function (AMF) of the UE; where the UE capability information indicates whether the UE supports transfer optimization or initiative selective packet discarding performed by a user plane function (UPF) on service data of the UE.

An eighth aspect of the embodiments of the present disclosure provides an information processing apparatus, including:
a second receiving module, configured to receive user equipment (UE) capability information sent by an access network function node;
a third sending module, configured to send the UE capability information to a policy control function (PCF) or a session management function (SMF), where the UE capability information indicates whether a UE supports transfer optimization or initiative selective packet discarding performed by a user plane function (UPF) on service data of the UE.

A ninth aspect of the embodiments of the present disclosure provides an information processing apparatus, including:
a third receiving module, configured to receive user equipment (UE) capability information provided by an access management function (AMF), where the UE capability information indicates whether a UE supports transfer optimization or initiative selective packet discarding performed by a user plane function (UPF) on service data of the UE.

A tenth aspect of the embodiments of the present disclosure provides an information processing apparatus, including:
a fourth receiving module, configured to receive rule information, where the rule information is generated according to UE capability information; where the UE capability information indicates whether a UE supports transfer optimization or initiative selective packet discarding performed by the UPF on service data of the UE.

An eleventh aspect of the embodiments of the present disclosure provides a communication device, including: a processor, a transceiver, a memory, and an executable program stored in the memory and executable by the processor, where the processor executes the executable program to implement the information processing method according to any one of the above first to fifth aspects.

A twelfth aspect of the embodiments of the present disclosure provides a computer storage medium, storing an executable program; when the executable program is executed by a processor, the information processing method according to any one of the above first to fifth aspects is implemented.

According to the technical solution provided by the embodiments of the present disclosure, the UE reports the UE capability information indicating whether the UE supports transfer optimization or initiative selective packet discarding performed by the UPF on the service data of the UE. In such way, when congestion occurs in the access network, the UPF performs transfer optimization or initiative selective packet discarding, to reduce network congestion and unnecessary traffic cost, thereby improving UE communication quality.

It should be understood that the above general description and the following detailed description are only examples and illustrative, and do not limit the embodiments of the present disclosure.

### BRIEF DESCRIPTION OF DRAWINGS

The accompanying drawings, which are incorporated in and constitute a part of this specification, illustrate embodiments consistent with the present disclosure, and together with the description serve to describe the principles of the embodiments of the present disclosure.

FIG. 1 is a schematic structural diagram of a wireless communication system according to an example embodiment.

FIG. 2 is a schematic flow diagram of an information processing method according to an example embodiment.

FIG. 3A is a schematic flow diagram of an information processing method according to an example embodiment.

FIG. 3B is a schematic flow diagram of an information processing method according to an example embodiment.

FIG. 3C is a schematic flow diagram of an information processing method according to an example embodiment.

FIG. 4 is a schematic flow diagram of an information processing method according to an example embodiment.

FIG. 5 is a schematic flow diagram of an information processing method according to an example embodiment.

FIG. 6 is a schematic flow diagram of an information processing method according to an example embodiment.

FIG. 7 is a schematic flow diagram of an information processing method according to an example embodiment.

FIG. 8 is a schematic flow diagram of an information processing method according to an example embodiment.

FIG. 9 is a schematic flow diagram of an information processing method according to an example embodiment.

FIG. 10 is a schematic flow diagram of an information processing method according to an example embodiment.

FIG. 11 is a schematic flow diagram of an information processing method according to an example embodiment.

FIG. 12 is a schematic structural diagram of an information processing apparatus according to an example embodiment.

FIG. 13 is a schematic structural diagram of an information processing apparatus according to an example embodiment.

FIG. 14 is a schematic structural diagram of an information processing apparatus according to an example embodiment.

FIG. 15 is a schematic structural diagram of an information processing apparatus according to an example embodiment.

FIG. 16 is a schematic structural diagram of an information processing apparatus according to an example embodiment.

FIG. 17 is a schematic structural diagram of a UE according to an example embodiment.

FIG. 18 is a schematic structural diagram of a communication device according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of embodiments of the present disclosure.

The terminology used in the embodiments of the present disclosure is for the purpose of describing particular embodiments only and is not intended to limit the embodiments of the present disclosure. Singular forms of “a,” “the,” and “said” used in the present disclosure are also intended to include plural forms unless the context clearly indicates otherwise. It should also be understood that the term “and/or” as used herein refers to and includes any or all possible combinations of one or more associated listed items.

It should be understood that although the terms “first,” “second,” “third,” etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information,” and similarly, “second information” may also be referred to as “first information.” Depending on the context, “if” as used herein may be interpreted as “when,” “upon,” or “in response to determining.”

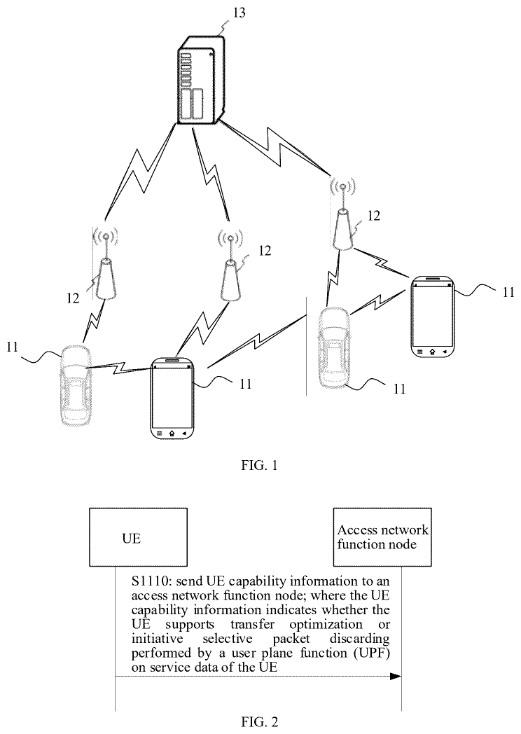

FIG. 2 is a schematic structural diagram of a wireless communication system according to an embodiment of the present disclosure. As shown in the drawings, a wireless communication system is a cellular mobile communication technology-based communication system, and the wireless communication system may include several terminals 11 and several access devices 12.

The terminal 11 may be a device that provides voice and/or data connectivity to a user. The terminal 11 may communicate with one or more core networks through a radio access network (RAN), and the terminal 11 may be Internet of Things terminal, such as a sensor device, a mobile phone (or referred to as a “cellular” phone), and a computer having the Internet of Things terminal, for example, may be a fixed, portable, pocket-sized, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user device, or a user equipment. Alternatively, the terminal 11 may be a device of an unmanned aerial vehicle. Alternatively, the terminal 11 may be an in-vehicle device, for example, may be a vehicle computer having a wireless communication function, or a wireless communication device externally connected to a vehicle computer. Alternatively, the terminal 11 may be a roadside device, for example, a street lamp, a signal light, or another roadside device having a wireless communication function.

The access device 12 may be a network side device in a wireless communication system. The wireless communication system may be a 4th generation mobile communication (4G) system, also referred to as a long term evolution (LTE) system; or the wireless communication system may be a 5G system, also referred to as a new radio system or a 5G NR system. Alternatively, the wireless communication system may be a next-generation system of a 5G system, or the like. The access network in the 5G system may be referred to as a new generation-radio access network (NG-RAN). Alternatively, a machine type communication (MTC) system.

The access device 12 may be an evolved NodeB (eNB) access device used in a 4G system. Alternatively, the access device 12 may be an access device (gNB) in a centralized-distributed architecture in a 5G system. When the access device 12 uses a centralized-distributed architecture, the access network device 12 usually includes a central unit (CU) and at least two distributed units (DU). The centralized unit is provided with a protocol stack of a Packet Data Convergence Protocol (PDCP) layer, a Radio Link Control (RLC) layer, and a Media Access Control (MAC) layer; and the distributed unit is provided with a protocol stack of a Physical (PHY) layer, which is not limited in the embodiments of the present disclosure

A wireless connection may be established between the access device 12 and the terminal 11 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard of 5G.

As shown in FIG. 2, an embodiment of the present disclosure provides an information processing method, performed by a user equipment (UE), including:
S1110: sending UE capability information to an access network function node;
where the UE capability information indicates whether the UE supports transfer optimization or initiative selective packet discarding performed by a user plane function (UPF) on service data of the UE.

The UE may include various types of terminal devices, and the terminal devices include but are not limited to a mobile phone, a tablet computer, a wearable device, an in-vehicle device, a smart home device, and/or a smart office device.

The UE sends the UE capability information to the access network function node, so as to inform the network node the capability possessed or supported by the UE itself through the UE capability information.

For example, the UE sends an access network (AN) message to the access network function node, and the AN message may include the foregoing UE capability information.

The access network function node includes but is not limited to: an access network function node of a terrestrial network (TN) and/or an access node of a non-terrestrial network (NTN).

In the embodiment of the present disclosure, the UE capability information indicates whether the UE supports transfer optimization or initiative selective packet discarding performed by the UPF on service data of the UE.

Further, the UE capability information herein may indicate whether the UE supports transfer optimization or initiative selective packet discarding performed by the UPF on service data of the UE based on a prediction result or based on an AN notification.

Both the prediction result and/or the AN notification may enable the UPF to know whether network congestion currently occurs or is about to occur.

In some embodiments, the UE capability information may include one or more indication bits, and different bit values of the indication bits may indicate a capability of the UE to support or not support transfer optimization or initiative selective packet discarding performed by the UPF on service data of the UE. That is, the UE capability information may be explicitly indicated.

In some other embodiments, the UE capability information may indicate whether the UE supports transfer optimization or initiative selective packet discarding performed by the UPF on the service data of the UE by using remaining bit values of a related information element (IE) or container, so that a new IE or container or an extended bit in an old IE and container may not be additionally added to specifically indicate whether the UE supports transfer optimization or initiative selective packet discarding performed by the UPF on the service data of the UE.

In some other embodiments, the UE capability information may implicitly indicate whether the UE supports the transfer optimization or initiative selective packet discarding performed by the UPF on the service data of the UE, for example, implicit indication is performed by using parameters such as different coding manners and different lengths of the UE capability information.

In the embodiment of the present disclosure, the UE capability information may indicate a UE granularity capability rather than a certain session, a data flow or a certain service. Certainly, the UE capability indicated by the UE capability information may also be associated with a session, a data flow, a service, or the like.

For example, if the UE has capability of supporting transfer optimization or initiative selective packet discarding performed by the UPF on service data of the UE, it may be determined, based on a user indication received by the UE and/or setting information of the UE, whether the UE supports transfer optimization or initiative selective packet discarding performed by the UPF on service data of the UE. For example, if the UE has capability of supporting transfer optimization or initiative selective packet discarding performed by the UPF on the service data of the UE, and the user indication or the setting information of the UE indicates that the UE agrees to support transfer optimization or initiative selective packet discarding performed by the UPF on the service data of the UE, the UE capability information indicates to the network node that the UE supports transfer optimization or initiative selective packet discarding performed by the UPF on the service data of the UE; otherwise, the UE may indicate to the network node that the UE does not support transfer optimization or initiative selective packet discarding performed by the UPF on the service data of the UE.

For another example, if the UE does not have capability of supporting the transfer optimization or initiative selective packet discarding performed by the UPF on the service data of the UE, it may be directly determined that the UE does not support transfer optimization or initiative selective packet discarding performed by the UPF on the service data of the UE.

In this embodiment, the service data may be data of any service subscribed or receivable by the UE. For example, the service data includes but is not limited to service data of an XRM service.

For example, transfer optimization or initiative selective packet discarding performed by the UPF on the service data of the UE may be downlink service data and/or uplink service data for the UE.

The transfer optimization may include at least one of:
when congestion occurs or congestion is expected to occur, service data with higher service priority is transmitted in priority according to setting of service priorities;
when congestion occurs or congestion is expected to occur, service data with less maximum tolerable delay is transmitted in priority according to the maximum tolerable delay; or
when congestion occurs or congestion is expected to occur soon, service data with higher service priority is allocated with transmitting resources in priority.

For example, on a video conference, a service priority of image data on the video conference may be lower than a service priority of audio data.

In various forms (or modes) of service data related to the XRM service, a service priority of audio data may be higher than a service priority of image data, and the service priority of image data may be higher than a service priority of haptic service data.

It may be considered that service data with higher priority generally has less maximum tolerable delay.

Certainly, the above is only an example of the service priority and/or the maximum tolerable delay, and the specific implementation is not limited to the above example.

The initiative selective packet discarding may include initiatively discarding some data packets when congestion occurs or when congestion is expected to occur. In this way, the discarded data packet will not be transmitted to the AN or the UE, thereby reducing congestion of the AN and reception of redundant data packets of the UE.

The initiative selective packet discarding may specifically include at least one of:
discarding a first-type data packet, where the first-type data packet may include data packet that can be decoded only based on a second-type data packet; where the second-type data packet may be a data packet that can be decoded independently; for example, assuming that a second-type data packet relied upon by a first-type data packet has been discarded or damaged to be undecodable due to a network problem, the first-type data packet may be discarded at this time;
discarding a first-type data packet and/or a second-type data packet of which a bit error rate reaches a preset value; and discarding redundant data packets; for example, in some cases, redundant data packets are transmitted to achieve high-quality decoding, for example, repeated transmissions; at this time, if it is determined that network congestion occurs or congestion is expected to occur, the redundant data packets may be discarded;
discarding expired data packets not reached to the UE; for example, different services have different quality of service (QoS), and if an actual delay of a part of data packets exceeds a delay corresponding to QoS due to network congestion, the UE may have requested retransmission or the server has sent a retransmitted data packet, this part of data packets may be discarded.

The network congestion or network bottleneck herein includes but is not limited to: congestion and/or bottleneck of an AN.

The UE initiatively reports, to the access network function node, whether the UE supports transfer optimization or initiative selective packet discarding performed by the UPF on service data of the UE, so that the UPF can conveniently reduce network congestion and reduce unnecessary traffic consumption by transfer optimization or initiative selective packet discarding when the access network is congested, thereby improving communication quality of the UE.

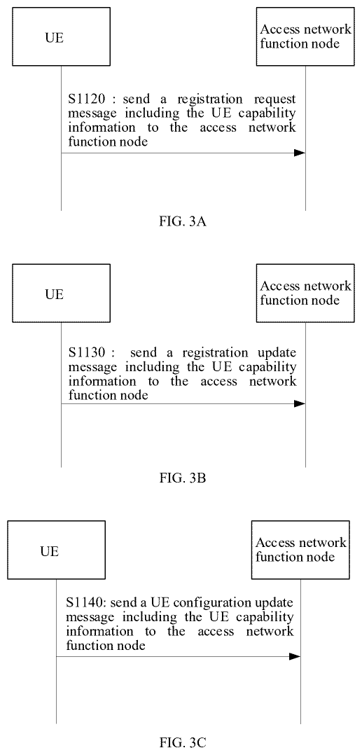

As shown in FIG. 3A, an embodiment of the present disclosure provides an information processing method, performed by UE, including:
S1120: sending a registration request message including the UE capability information to the access network function node.

As shown in FIG. 3B, an embodiment of the present disclosure provides an information processing method, performed by a UE, including:
S1130: sending a registration update message including the UE capability information to the access network function node.

As shown in FIG. 3C, an embodiment of the present disclosure provides an information processing method, performed by a UE, including:
S1140: sending a UE configuration update message including the UE capability information to the access network function node.

The three embodiments shown in FIG. 3A to FIG. 3C may be used to report UE capability information. That is, all the three implementations are possible implementations of sending the UE capability information to the access network function node in S1110. In the embodiment of the present disclosure, the reported UE capability information may indicate whether the UE supports transfer optimization or initiative selective packet discarding performed by a user plane function (UPF) on service data of the UE.

For example, when the UE is powered on and performs a first-time registration after being powered on, the UE sends a registration request message to the access network function node. In this case, the access network function node may obtain the UE capability information in the registration request message, so that the access network function node may transmit service data by using the capability of the UE in a service provision process after the UE registers to the network.

When the UE performs registration update due to various factors such as change of a tracking area update (TAU) of the UE, an access management function (AMF) that performs access management on the UE may be reselected, that is, a serving AMF of the UE is reselected, the UE carries the UE capability information in the registration update request message, and the new AMF of the UE can also receive the UE capability information through the access network function node, instead of through the previous AMF of the UE. Certainly, in some embodiments, if the UE capability information is updated, the UE capability information may also be used as a trigger event for the UE to send the registration update request message to the AN, and the registration update request message sent in this case also carries the UE capability information, at this time, the network side may not perform registration update, but to update the UE capability information stored in the network side.

In some embodiments, the network side configures the UE, for example, configures information such as a registration update timer, and in these UE configuration processes involving the core network node, the UE may report the UE capability information to the network device through a UE configuration update message. For example, the UE capability information is carried in a UE configuration update request message or a UE configuration update complete message.

In conclusion, in any case, the UE capability information is sent to the access network function node in a message related to the entire UE, and the access network function node forwards the UE capability information to the AMF for storage.

In an embodiment of the present disclosure, the service data includes:
service data of an extended reality and media (XRM) service or service data of a multimodal service.

For example, the service data of the XRM may include data of an AR service, a VR service, and/or various XR services, and/or game data of cloud games. The data of the multimodal service may generally relate to multiple output devices and/or multiple input devices. For example, audio input/output devices, video input/output devices, touch devices, and/or sensors, etc.

In some embodiments, the UE capability information carries a mobility management core network (MM CN) capability parameter of the UE.

For example, the AN message sent by the UE to the access network function node may carry various parameters, and these parameters include but are not limited to at least one of:
a tracking area identifier (TAI) of a TA that is last visited by the UE;
a security parameter, indicating a possessed or required security capability of the UE; for example, the security parameter may indicate a security algorithm supported by the UE; the security algorithm includes but is not limited to: a confidentiality security algorithm and/or an integrity security algorithm;
UE radio capability information, indicating radio capability of the UE, for example, indicating whether the UE has multiple antenna panels, and whether the UE supports multiple connections and/or multiple carriers, etc.;
UE MM CN capability information, indicating MM CN capability possessed or supported by the UE. In the embodiments of the present disclosure, the capability of the UE to support or not support transfer optimization or initiative selective packet discarding performed by the UPF on the service data may belong to one of the MM CN capabilities of the UE. The UE capability information is carried in the UE MM CN capability information. After receiving the UE MM CN capability information, the AN may directly forward or transmit the UE MM CN capability information to the core network node in a pass-through mode without extra information analysis or processing. In this way, whether the UE supports transfer optimization or initiative selective packet discarding performed by the UPF on the service data of the UE can be implemented without constructing a new message or an information element (IE), thereby having a characteristic of high compatibility.

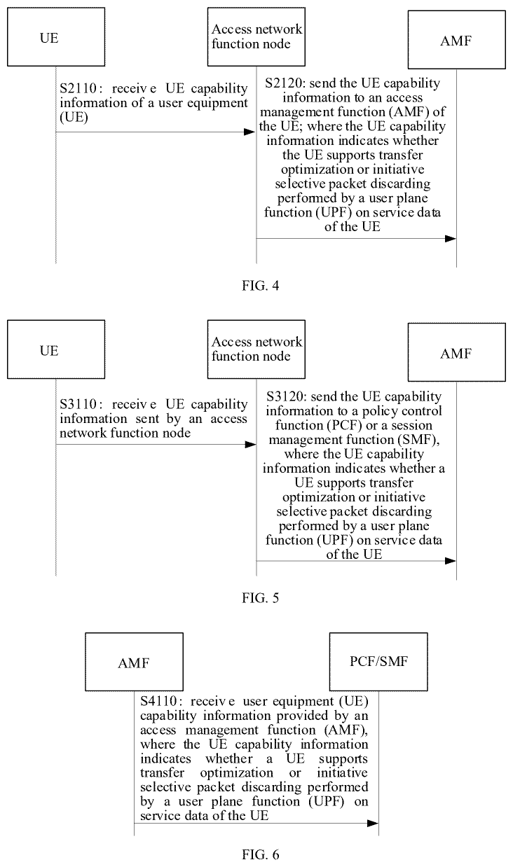

As shown in FIG. 4, an embodiment of the present disclosure provides an information processing method, performed by an access network function node, including:
S2110: receiving UE capability information of a user equipment (UE); and
S2120: sending the UE capability information to an access management function (AMF) of the UE; where the UE capability information indicates whether the UE supports transfer optimization or initiative selective packet discarding performed by a user plane function (UPF) on service data of the UE.

The access network function node may include various types of base stations, for example, a TN base station or an NTN base station. For another example, the access network function node may be an evolved base station (eNB) and/or a next generation base station (gNB).

In the embodiment of the present disclosure, after receiving the UE capability information of the UE, the access network function forwards or transmits the UE capability information to the AMF in a pass-through manner, where the AMF may be a serving AMF of the UE. For example, the AMF may be a serving AMF of the UE.

For example, the UE capability information one of the UE MM CN information. For example, the IE carries various UE MM CN information, so that after receiving the IE, the access network function node sends the IE to the serving AMF of the UE, so that the AMF of the UE stores the IE.

In some embodiments, receiving the UE capability information of the UE includes one of:
receiving a registration request message including the UE capability information;
receiving a registration update message including the UE capability information; or receiving a UE configuration update message including the UE capability information.

If the UE capability information is carried in the registration request message or the registration update message, before sending the UE capability information to the AMF, the access network function node needs to select a serving AMF for the UE or reselect the AMF, so as to determine the AMF that receives the UE capability information.

Certainly, the UE capability information may also be carried in a UE configuration update message and sent to the AMF.

In conclusion, the access network function node may receive UE capability information by using various messages of the UE, and transmit the UE capability information to the AMF by using any message exchanged between the access network function node and the AMF.

As shown in FIG. 5, an embodiment of the present disclosure provides an information processing method, performed by an AMF, including:
S3110: receiving UE capability information sent by an access network function node;
S3120: sending the UE capability information to a policy control function (PCF) or a session management function (SMF), where the UE capability information indicates whether a UE supports transfer optimization or initiative selective packet discarding performed by a user plane function (UPF) on service data of the UE.

In this embodiment of the present disclosure, the AMF receives the UE capability information from the access network function node such as a base station. The AMF includes an AMF of the UE. After receiving the UE capability information, the AMF stores the UE capability information. When appropriate, the UE capability information is carried in various messages and sent to the PCF or the SMF.

For example, the S3120 may include at least one of:
sending, by the AMF, the UE capability information straightforward to the PCF;
sending, by the AMF, the UE capability information straightforward to the SMF; or sending, by the AMF, the UE capability information to the SMF, so that the SMF forwards the UE capability information to the PCF.

If the network node designated according to the UE policy information is the PCF, the AMF may submit the UE capability information to the PCF straightforward or through the SMF.

If the policy information is determined by the SMF, after the AMF directly sends the UE capability information to the SMF, the UE capability information does not need to be further submitted to the PCF.

In conclusion, in this embodiment of the present disclosure, after receiving the UE capability information sent by the access network function node, the AMF sends the UE capability information to a core network node such as an SMF or a PCF to determine the policy information.

The policy information herein includes but is not limited to one or more policy control and charging (PCC) rules.

The PCC rules may be further converted to N4 rules that are directly usable by the UPF. For example, if the UE capability information indicates that the UE supports transfer optimization or initiative selective packet discarding performed by the UPF on the service data of the UE, the N4 rule may indicate the UPF to perform transfer optimization or initiative selective packet discarding on the service data of the UE when network congestion occurs or network congestion is about to occur. If the UE capability information indicates that the UE does not support transfer optimization or initiative selective packet discarding performed by the UPF on the service data of the UE, the N4 rule may indicate the UPF not to allow transfer optimization or initiative selective packet discarding of the service data of the UE even when network congestion occurs or network congestion is about to occur.

The service data herein includes but is not limited to XRM service data and/or service data of a multimodal service.

In some embodiments, sending the UE capability information to the PCF or the SMF includes at least one of:
sending the UE capability information to the PCF in an establishment or updating procedure of an access management association of the UE;
sending the UE capability information to the PCF in an establishment or updating procedure of a policy association of the UE; or
sending the UE capability information to the SMF in an establishment or updating procedure of a protocol data unit (PDU) session.

In this way, to reduce unnecessary message transmission between the AMF and the PCF and/or the SMF, and not specifically configure transmission of the UE capability information, the UE capability information may be sent to the PCF by using any message associated with access management in a procedure of establishing an access management association between the AMF and the PCF. In the access management association, the AMF establishes association with the serving PCF of the UE.

For example, in a procedure of establishing or updating a UE policy association, the AMF triggers the PCF to establish or update policy information of the UE by exchanging information with the PCF. In the embodiment of the present disclosure, the UE capability information may be sent to the PCF in any message in the procedure of establishing or updating the UE policy association.

If the AMF needs to send the UE capability information to the SMF or forward the UE capability information to the PCF through the SMF, to reduce unnecessary information exchange, the AMF adds the UE capability information to any message in a procedure in which PDU sessions of the UE is established or updated, and provides the UE capability information to the SMF.

It should be noted that the above is merely an example in which the AMF separately provides the UE capability information to the PCF and/or the SMF, and specific implementation is not limited to providing the UE capability information to the PCF and/or the SMF in the above procedure.

For example, the PCF and/or the SMF may initiatively request or query the UE capability information from the AMF, and in this case, the AMF may send the UE capability information to the PCF and/or the SMF by using a request message or a query message.

In some embodiments, sending the UE capability information to the PCF or the SMF includes:
sending the UE capability information to the PCF or the SMF based on a subscription request, an operator policy, or a subscription configuration;
or,
sending the UE capability information to the PCF or the SMF in response to determining that a subscription event is triggered.

For example, the AMF may receive a subscription request of the PCF or the SMF, so that when receiving the UE capability information or determining that the UE capability information is updated, the AMF may send the UE capability information to the PCF or the SMF in a manner of a subscription notification, or when receiving the UE capability information or determining that the UE capability information is updated, the AMF may provide the UE capability information to the PCF or the SMF in a message of any of the foregoing procedures.

The operator policy may include a policy formulated by an operator of the communication network, and the AMF may provide the UE capability information to the PCF or the SMF based on the policy.

The subscription configuration may be a configuration formulated when the UE and the communication operator subscribe to the communication service, and the AMF may locally store the operator and/or the subscription policy, or may request the operator policy and/or the subscription configuration from the PCF, and send the UE capability information to the PCF or the SMF when a sending condition formulated by the operator policy or the subscription configuration is met. For example, the UE capability information may be periodically reported to the PCF or the SMF.

As shown in FIG. 6, an embodiment of the present disclosure provides an information processing method, performed by a PCF or an SMF, including:
S4110: receiving user equipment (UE) capability information provided by an access management function (AMF), where the UE capability information indicates whether a UE supports transfer optimization or initiative selective packet discarding performed by a user plane function (UPF) on service data of the UE.

The PCF directly receives the UE capability information from the AMF, or receives the UE capability information provided by the AMF from the SMF. In conclusion, the UE capability information may be used to indicate whether the UE supports transfer optimization or initiative selective packet discarding performed by the UPF on the service data.

After receiving the UE capability information from the AMF, the PCF or the SMF may know whether the UE supports transfer optimization or initiative selective packet discarding performed by the UPF on service data of the UE, and may subsequently generate a corresponding PCC rule based on the UE capability information when formulating policy information of the UE.

Certainly, it should be noted that when the policy information of the UE is formulated, reference may be made to other conditions such as subscription information of the UE and/or operator configuration.

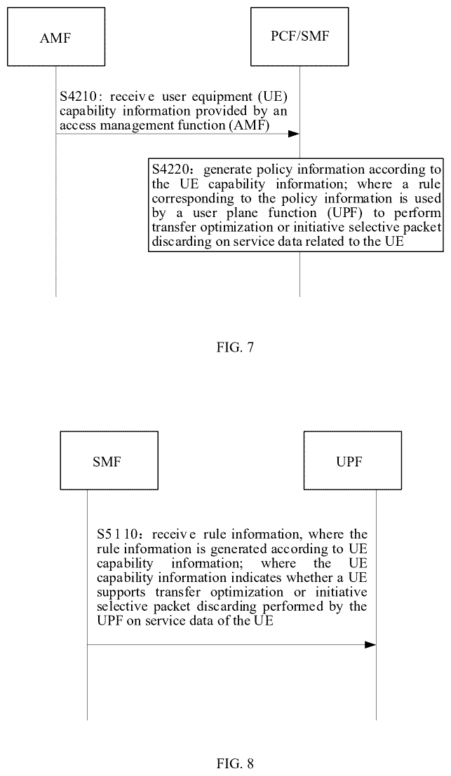

As shown in FIG. 7, an embodiment of the present disclosure provides an information processing method, performed by a PCF or an SMF, including:
S4210: receiving user equipment (UE) capability information provided by an access management function (AMF), where the UE capability information indicates whether a UE supports transfer optimization or initiative selective packet discarding performed by a user plane function (UPF) on service data of the UE.
S4220: generating policy information according to the UE capability information; where a rule corresponding to the policy information is used by a user plane function (UPF) to perform transfer optimization or initiative selective packet discarding on service data related to the UE.

In this embodiment of the present disclosure, the PCF and/or the SMF generate the policy information based on the UE capability information.

For example, if the PCF generates the policy information, the PCF may refer to the UE capability information. The PCC rule formulated by the PCF may be delivered to the SMF, and the SMF may further generate an N4 rule proper to be executed by the UPF.

For another example, the SMF may directly generate, based on the UE capability information, the N4 rule that can be executed by the UPF.

In some embodiments, the policy information includes at least one of:
an optimization granularity, indicating a quality of service (QoS) flow, a data flow, a protocol data unit (PDU) set, or a data packet on which the transfer optimization or the initiative selective packet discarding is performed by the UPF; or,
an optimization condition, indicating a condition to be met when the UPF performs the transfer optimization or the initiative selective discarding.

The optimization granularity indicates a granularity for performing transfer optimization or initiative selective packet discarding on a data packet, for example, for a QoS flow, a data flow, a PDU set, and/or a single data packet.

The data flow may include a session flow, a service data flow, or a QoS flow.

A PDU set includes one or more PDUs. A PDU may include a packet.

The above is merely an example of an optimization granularity, and in a specific implementation process, the optimization granularity may further include: a session group.

After the optimization condition is met, the UPF may start transfer optimization or initiative selective packet discarding on service data of the UE.

In some embodiments, the optimization condition includes at least one of:
a time window;
a traffic threshold; or
a packet error rate.

The time window may be used by the UPF to determine a time period for performing transfer optimization or initiative selective packet discarding on service data of the UE. Time information corresponding to the time window may include start and end time information of the time window, start time information of the time window, and a time window length.

In an embodiment, the traffic threshold may include a packet discarding threshold and/or an optimization threshold.

For example, when the UPF finds that an amount of data packets accumulated in a UE reaches the packet discarding threshold, it may be considered that an optimization condition for the UPF to perform initiative selective packet discarding on service data of the UE is met.

For example, when the UPF finds that an amount of data packets accumulated in a UE reaches the optimization threshold, it may be considered that an optimization condition for the UPF to perform transfer optimization on service data of the UE is met.

In some embodiments, the packet error rate may be: when determining that an actual packet error rate of the UE reaches the packet discarding ratio defined by the optimization condition, the AN or the UPF further performs packet discarding or transfer optimization of remaining data packets.

In some other embodiments, the optimization condition may further include at least one of:
a tolerable delay budget of a data flow, a PDU set, or a data packet exceeds a PDU Set Delay Budget (PSDB)
an actual error rate is greater than an error rate threshold; or
delivery failure of an important PDU set/important packet.

If the tolerable delay budget of the data flow/PDU set/data packet exceeds the PSDB, it indicates that the data flow/PDU set/data packet is not urgent, and therefore packet discarding or transfer optimization is performed when the network is congested or is about to be congested, thereby alleviating the network congestion condition.

The error rate of the data flow/PDU set/data packet is too high to be transmitted to the UE or the server and cannot be decoded normally, so that when the network is congested or about to be congested, discarding or transfer optimization can be performed, thereby relieving the network congestion.

For example, delivery failure of an important PDU set/important data packet may cause that a series of data packets cannot be decoded, and an optimization condition may also be met, to trigger the UPF to discard or optimize the remaining data packets of the UE, so as to alleviate network congestion.

As shown in FIG. 8, an embodiment of the present disclosure provides an information processing method, performed by a UPF, including:
S5110: receiving rule information, where the rule information is generated according to UE capability information; where the UE capability information indicates whether a UE supports transfer optimization or initiative selective packet discarding performed by the UPF on service data of the UE.

The UPF receives rule information, where the rule information includes but is not limited to an N4 rule.

For example, the UPF receives the N4 rule from the SMF. The rule information is generated according to UE capability information initiatively provided by the UE, so that the UPF performs transfer optimization or initiative selective packet discarding of the service data according to the rule information, which can be supported by the UE capability and/or willingness.

For example, S5110 may include: receiving the N4 rule provided by the SMF.

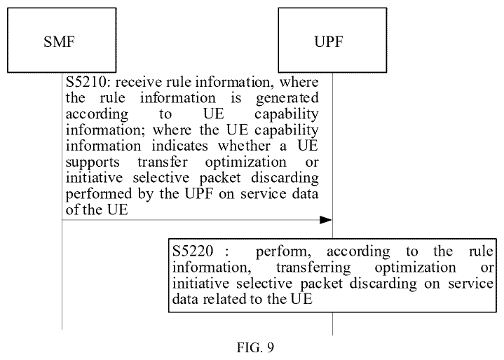

As shown in FIG. 9, an embodiment of the present disclosure provides an information processing method, performed by a UPF, including:
S5210: receiving rule information, where the rule information is generated according to UE capability information; where the UE capability information indicates whether a UE supports transfer optimization or initiative selective packet discarding performed by the UPF on service data of the UE.
S5220: performing, according to the rule information, transfer optimization or initiative selective packet discarding on service data related to the UE.

The UE-related service data herein may include: any UE-related service data and/or UE-related service-specific service data. Specific services herein include, but are not limited to, XRM services and/or multimodal services.

For example, the S5220 may include:
when the rule information indicates that the UPF is allowed to perform transfer optimization or initiative selective packet discarding on the service data related to the UE, performing the transfer optimization or initiative selective packet discarding on the service data related to the UE when an optimization condition is achieved;
or,
when the rule information indicates that the UPF is not allowed to perform the transfer optimization or initiative selective packet discarding on the service data related to the UE, when an optimization condition is met, transfer optimization or initiative selective packet discarding is not performed on the service data related to the UE.

In some embodiments, performing, according to the rule information, the transfer optimization or initiative selective packet discarding on the service data related to the UE includes:
performing the transfer optimization or initiative selective packet discarding on the service data related to the UE according to the rule information, and at least one of a prediction result provided by a network data analytics function (NWDAF) or a notification of an access network function node.

The NWDAF may collect subscription data, service behavior data, and/or network behavior data of the UE, and may predict whether network congestion occurs or is about to occur in the current UE, or whether a UE terminal status triggers a condition of transfer optimization or initiative selective packet discarding.

If the NWDAF notifies the UPF that network congestion occurs or network congestion is about to occur, or whether the UE terminal status triggers a condition of transfer optimization or initiative selective packet discarding, the UPF may select, based on rule information, to perform transfer optimization or initiative selective packet discarding on all or some service data of the UE.

In some embodiments, a prediction result provided by the NWDAF may include at least one of:
a congestion indication, indicating that a network congestion occurs, for example, an AN congestion occurs;
a congestion prediction indication, indicating that the network congestion is about to occur, or indicating a time period of congestion; or
a cause indication, indicating a cause of the network congestion.

If the prediction result further includes the cause indication, in a specific implementation, the UPF may further determine, according to the cause indication, a data packet to be discarded or to be performed with transfer optimization. For example, if a data flow causing network congestion is a specific data flow, and the specific data flow supports transfer optimization or initiative selective packet discarding, the UPF can perform the transfer optimization or initiative selective packet discarding on service data of the UE for the specific data flow.

In some other embodiments, the AN exchanges data packets with the UE, and if the UPF keeps transmitting data packets to the AN when congestion has already occurred in the AN, further congestion will be caused in the AN. In this case, the AN may send a notification to the UPF to trigger the UPF to perform transfer optimization or initiative selective packet discarding according to the rule information.

For example, the notification may include at least one of:
an enable instruction, configured to instruct the UPF to enable transfer optimization or initiative selective packet discarding;
a terminate indication, configured to instruct the UPF to terminate transfer optimization or initiative selective packet discarding;
an optimization period, configured to indicate a time period for the UPF to perform transfer optimization or initiative selective packet discarding; or
an optimization parameter, configured to indicate a packet discarding rate, an amount of data to be discarded, or an amount of data for the transfer optimization, for specified transfer optimization or initiative selective packet discarding.

In some other embodiments, the notification may further include: a suggestion parameter, where the suggestion parameter may suggest the UPF to determine a data packet to be discarded or to be performed with transfer optimization.

Certainly, the above is only an example of notifying the included content, and the specific implementation is not limited to the above examples.

In some embodiments, performing the transfer optimization or initiative selective packet discarding on the service data related to the UE according to the rule information, and at least one of a prediction result provided by a network data analytics function (NWDAF) or a notification of an access network function node includes:
performing the transfer optimization or the initiative selective packet discarding on the service data related to the UE in response to determining that at least one of the prediction result provided by the NWDAF or the notification of the access network function node indicates that the service data of the UE meets an optimization condition corresponding to the rule information.

For example, when both the prediction result provided by the NWDAF and/or the notification of the access network function node indicate that the service data of the UE meets the optimization condition, that is, indicate that packet discarding or transfer optimization needs to be performed, the UPF performs transfer optimization or initiative selective packet discarding on the service data related to the UE according to the rule information.

Further, the rule information, and at least one of the prediction result provided by the NWDAF or the notification of the access network function node indicate to perform the transfer optimization or initiative selective packet discarding on the service data related to the UE includes:
performing the transfer optimization or initiative selective packet discarding on the service data related to the UE according to the rule information, and at least one of the prediction result provided by the NWDAF or the notification of the access network function node, and an optimization granularity corresponding to the rule information.

If the rule information defines the optimization granularity, the UPF performs transfer optimization or initiative selective packet discarding of service data of a corresponding granularity based on the optimization granularity. For example, if the optimization granularity is a QoS flow, the UPF performs transfer optimization or initiative selective packet discarding on service data of the QoS flow. In a case the optimization granularity being a data flow, the UPF performs the transfer optimization or initiative selective packet discarding on the service data of the data flow. In a case the optimization granularity being a PDU set, the UPF performs the transfer optimization or initiative selective packet discarding on the service data of the PDU set. In a case the optimization granularity being a data packet, the UPF performs the transfer optimization or initiative selective packet discarding on the service data of the data packet. The fifth generation mobile communication system (5GS) is studying how to optimize the data transferring of the RAN air interface based on the information such as dependency and importance priority between data units in the data set.

However, when network congestion occurs, current data flow transferring mechanisms still cannot quickly relieve congestion, for example, a manner of discarding data units exceeding a QoS delay threshold during congestion directly leads to unsatisfied service QoS, and user experience (quality of experience, QoE) is greatly reduced.

In view of this, embodiments of the present disclosure provide a network-side transferring enhancement capability negotiation solution, to improve QoS and QoE of service data transmission.

The UE provides UE capability information on whether the UE supports transfer optimization or initiative selective packet discarding performed by the UPF on downlink XRM data based on prediction (network analysis or RAN notification) to the network (PCF/SMF).

For example, the UE provides the UE capability information to the PCF or the SMF through procedures such as registration, mobile registration update, and/or UE configuration update. Specifically, the UE capability information may be carried in a UE 5GMM network capability parameter.

The PCF/SMF generates a corresponding policy rule, and performs transfer optimization or selective flow control on the downlink XRM data flow. For example, active packet discarding or transfer optimization triggered by an event such as network congestion.

The UPF installs a corresponding rule generated and delivered by the PCF/SMF, and performs transfer optimization or selective flow control on the downlink XRM data flow.

The optimization granularity may be: QoS flow, traffic, PDU set, or data packet.

The optimization condition may include: a specific time window, a specific traffic threshold, or a specific packet error rate.

For example, whether the optimization condition is currently met is determined according to the specific time window, the specific traffic threshold, or the specific packet error rate.

According to the solution, the competition of radio resources on the RAN side can be effectively relieved in cases such as network congestion, and the QoE (quality of experience) is improved, and the problem of inaccurate charging caused by packet error in RAN side transfer optimization can be effectively avoided.

Specifically, for example:
The UE sends UE capability information indicating whether the UE supports transfer optimization or initiative selective packet discarding performed by the UPF on downlink XRM data based on prediction (network analysis or RAN notification) to the network node.
The UE carries the UE capability information through any message in procedures such as registration, mobile registration update or UE configuration update, and finally transmits the UE capability information to the PCF or SMF.
After receiving the UE capability information (or referred to as capability information or a capability indication for short), the PCF or the SMF generates a corresponding policy rule, where the policy rule may enable the UPF to perform transfer optimization or selective flow control on the downlink XRM data flow of the UE.

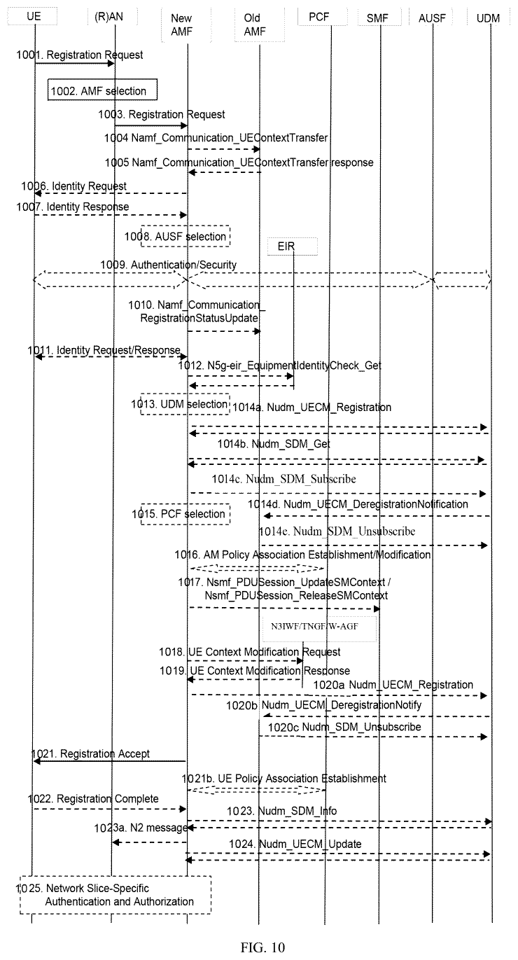

As shown in FIG. 10, an example in which UE capability information is sent based on a UE registration update procedure is used for description. The steps include:
Step 1001: the UE sends a non-access-stratum (NAS) message to an access network or a radio access network ((R)AN); and the ((R)AN) may pass through the NAS to the AMF. The NAS message shown in the figure may include a registration request message, and specific implementation is not limited to the registration request message. The registration request message carries UE MM CN capability information, where the UE MM CN capability information may include UE capability information indicating whether the UE supports transfer optimization performed by the UPF on service data of the UE or initiative selective packet discarding. For example, the UE capability information may indicate whether the UE supports transfer optimization or initiative selective packet discarding performed by the UPF on service data of the UE based on the prediction result.

Further, the UE capability information may indicate whether the UE supports transfer optimization or initiative selective packet discarding performed by UPF on downlink XRM data of the UE based on a prediction result or notification of an (R)AN.
Step 1002: upon receiving the registration request message of the UE, the (R)AN selects an AMF for the UE. The (R)AN refers to an AN/RAN.
Step 1003: send the registration request message to the selected AMF. Specifically, for example, the (R)AN selects a corresponding AMF, and forwards the registration request message of the UE to the AMF, where the N2 message carries the registration request message in step 1. The AMF stores the corresponding UE MM Core Network Capability in the UE context. If the UE provides UPF transferring based on prediction capability in step 1, the AMF stores the UPF transferring based on predictions capability (e.g., to the UE context). Transferring herein may include processing such as traffic steering of a corresponding data packet, a data packet set, a service data flow, or a QoS flow, switching path transmission, splitting and discarding.
Step 1004: the new AMF of the UE obtains the UE context from the old AMF through “Namf_Communication UE Context Transfer”.
Step 1005: new AMF receives “Namf_Communication UE ContextTransferResponse” returned by the old AMF, where the “Namf_Communication UE ContextTransferResponse” may include the UE context.
Step 1006: the UE receives an identity request message returned by the new AMF.
Step 1007: the UE returns an identity response message to the new AMF.
Step 1008: the new AMF selects an authentication server function (AUSF) for the UE.
Step 1009: security authentication.
Step 1010: the new AMF sends a “Namf_Communication_RegistrationStausUpdate” message to the old AMF.
Step 1011: an identifier request/response between the UE and the new AMF.
Step 1012: device identifier confirmation between the new AMF and an Equipment Identity Register (EIR).
Step 1013: the new AMF selects user data management (UDM) for the UE.
Steps 1014a to 1014 c: information exchange between the new AMF and the UDM may include registration of the new AMF with the UDM.
Steps 1014d to 1014d: information exchange between the old AMF and the UDM may include deregistration of the old AMF with the UDM.
Step 1015: PCF selection.
Step 1016: the AMF and the PCF perform policy association establishment or update. In the policy association establishment or update procedure, any message may be used to carry the UE capability information indicating whether the UE supports transfer optimization or initiative selective packet discarding performed by UPF on service data of the UE.
Step 1017: PDU session of the UE is established or released.
Step 1018: the UE transmits a context modification request message.
Step 1019: the UE transmits a context modification response message.
Steps 1020a to 1020c: deregistration related operations of the old AMF.
Step 1021a: the new AMF accepts registration of the UE.
Step 1021b: the new AMF and the PCF perform a policy association establishment procedure. In the policy association establishment procedure, any message may be used to carry the UE capability information indicating whether the UE supports transfer optimization or initiative selective packet discarding performed by UPF on service data of the UE.
Step 1022: the registration is completed.
Steps 1023-1025: remaining messages of the registration procedure.

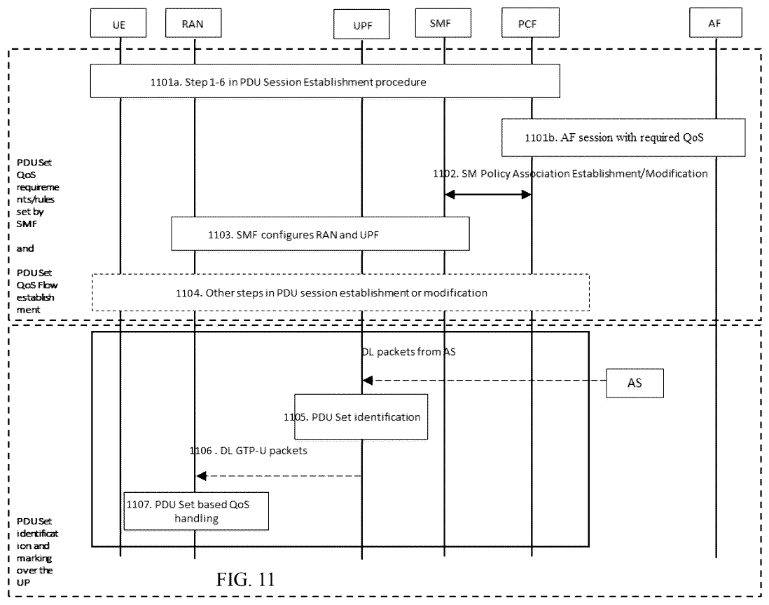

As shown in FIG. 11, transfer optimization or initiative selective packet discarding performed by the UPF on service data of the UE may occur in a PDU set transmission process, and may include:
Step 1101a: PDU session establishment procedure;
Step 1101b: determine required QoS;
Step 1102: session management (SM) policy association establishment or modification;
Step 1103: the SMF configures the RAN and the UPF;
Step 1104: other PDU session establishment or update procedures;
Step 1105: obtain a downlink data packet from an application server (AS), and obtain an ID of a corresponding PDU set;
Step 1106: the UPF sends a downlink data packet to the RAN; for example, when an event such as congestion is triggered, the UPF initiatively discards a packet, where an optimization granularity may be a QoS flow, a data flow, a PDU set, and/or a data packet. The optimization condition may include: a specific time window, a specific traffic threshold, and a specific packet error rate.
Step 1107: the RAN performs PDU set-level QoS handling. For example, if the RAN performs monitoring and reporting of the prediction condition, the RAN performs a QoS handling procedure of the PDU set. When the packet discarding trigger event is detected, the packet discarding event information or indication based on the PDU set is reported to the core network, so that the PCF generates and updates the corresponding rule.

The trigger event includes, but is not limited to: a congestion level being greater than a threshold, a packet error rate being greater than a threshold, a delay being greater than a threshold, a UE status related requirement, etc.

As shown in FIG. 12, an embodiment of the present disclosure provides an information processing apparatus, including:
a first sending module 100, configured to send user equipment (UE) capability information to an access network function node;
where the UE capability information indicates whether the UE supports transfer optimization or initiative selective packet discarding performed by a user plane function (UPF) on service data of the UE.

The information processing apparatus may be included within a UE.

For example, the first sending module 100 may be a program module, and the program module may implement the foregoing operations after being executed by the processor.

The first sending module 100 may further include a soft and hard combination module; the soft and hard combination module includes but is not limited to a programmable circuit; and the programmable circuit includes but is not limited to a field programmable circuit and/or a complex programmable circuit.

In some other embodiments, the first sending module 100 may be a hardware-only module, and the hardware-only module includes but is not limited to an application-specific integrated circuit.

In some embodiments, the information processing apparatus may further include: a storage module, where the storage module is connected to the first sending module 100 and may be at least configured to store the UE capability information.

In some embodiments, the first sending module 100 is configured to perform at least one of:
sending a registration request message including the UE capability information to the access network function node;
sending a registration update message including the UE capability information to the access network function node; or
sending a UE configuration update message including the UE capability information to the access network function node.

In some embodiments, the service data includes:
service data of an extended reality and media (XRM) service or service data of a multimodal service.

In some embodiments, the UE capability information carries a mobility management core network (MM CN) capability parameter of the UE.

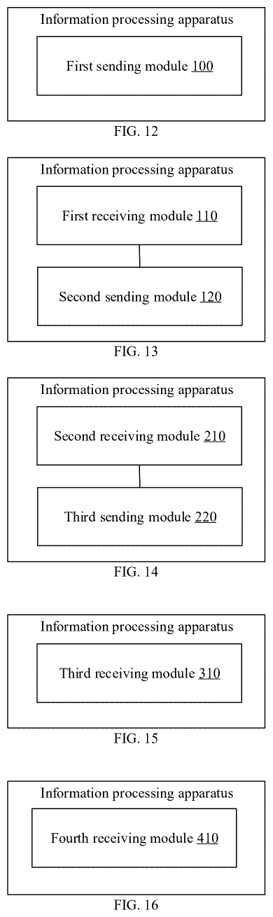

As shown in FIG. 13, an embodiment of the present disclosure provides an information processing apparatus, including:
a first receiving module 110, configured to receive user equipment (UE) capability information of a UE; and
a second sending module 120, configured to send the UE capability information to an access management function (AMF) of the UE; where the UE capability information indicates whether the UE supports transfer optimization or initiative selective packet discarding performed by a user plane function (UPF) on service data of the UE.

The information processing apparatus may be included in an access network function node such as a base station.

For example, the first receiving module 110 and the second sending module 120 may be program modules, and the program modules can implement the foregoing operations when being executed by the processor.

The first receiving module 110 and the second sending module 120 may further include a soft and hard combination module; the soft and hard combination module includes but is not limited to a programmable circuit; and the programmable circuit includes but is not limited to a field programmable circuit and/or a complex programmable circuit.

In some other embodiments, the first receiving module 110 and the second sending module 120 may be hardware-only modules; and the hardware-only modules include but are not limited to application-specific integrated circuits.

In some embodiments, the first receiving module 110 is configured to perform one of:
receiving a registration request message including the UE capability information;
receiving a registration update message including the UE capability information; or receiving a UE configuration update message including the UE capability information.

As shown in FIG. 14, an embodiment of the present disclosure provides an information processing apparatus, including:
a second receiving module 210, configured to receive user equipment (UE) capability information sent by an access network function node; and
a third sending module 220, configured to send the UE capability information to a policy control function (PCF) or a session management function (SMF), where the UE capability information indicates whether a UE supports transfer optimization or initiative selective packet discarding performed by a user plane function (UPF) on service data of the UE.

The information processing apparatus may include an AMF.

For example, the second receiving module 210 and the third sending module 220 may be program modules, and the program modules can implement the foregoing operations after being executed by the processor.

The second receiving module 210 and the third sending module 220 may further include a soft and hard combination module; the soft and hard combination module includes but is not limited to a programmable circuit; and the programmable circuit includes but is not limited to a field programmable circuit and/or a complex programmable circuit.

In some other embodiments, the second receiving module 210 and the third sending module 220 may be hardware-only modules; and the hardware-only modules include but are not limited to application-specific integrated circuits.

In some embodiments, the third sending module 220 is configured to perform at least one of:
sending the UE capability information to the PCF in an establishment or updating procedure of an access management association of the UE;
sending the UE capability information to the PCF in an establishment or updating procedure of a policy association of the UE; or
sending the UE capability information to the SMF in an establishment or updating procedure of a protocol data unit (PDU) session.

In some embodiments, the third sending module 220 is configured to: send the UE capability information to the PCF or the SMF based on a subscription request, an operator policy, or a subscription configuration; or send the UE capability information to the PCF or the SMF in response to determining that a subscription event is triggered.

As shown in FIG. 15, an embodiment of the present disclosure provides an information processing apparatus, including:
a third receiving module 310, configured to receive user equipment (UE) capability information provided by an access management function (AMF), where the UE capability information indicates whether a UE supports transfer optimization or initiative selective packet discarding performed by a user plane function (UPF) on service data of the UE.

The information processing apparatus may include an SFM or a PCF, etc.

For example, the third receiving module 310 may be a program module, and the program module may implement the foregoing operations after being executed by the processor.

The third receiving module 310 may further include a soft and hard combination module; the soft and hard combination module includes but is not limited to a programmable circuit; and the programmable circuit includes but is not limited to a field programmable circuit and/or a complex programmable circuit.

In some other embodiments, the third receiving module 310 may be a hardware-only module, and the hardware-only module includes but is not limited to an application-specific integrated circuit.

In some embodiments, the information processing apparatus may further include a storage module. The storage module is connected to the third receiving module 310, and may be at least configured to store the UE capability information.

In some embodiments, the apparatus further includes:
a generating module, configured to generate policy information according to the UE capability information; where a rule corresponding to the policy information is used by a user plane function (UPF) to perform transfer optimization or initiative selective packet discarding on service data related to the UE.

In some embodiments, the policy information includes at least one of:
an optimization granularity, indicating a quality of service (QoS) flow, a data flow, a protocol data unit (PDU) set, or a data packet on which the transfer optimization or the initiative selective packet discarding is performed by the UPF; or,
an optimization condition, indicating a condition to be met when the UPF performs the transfer optimization or the initiative selective discarding.

In some embodiments, the optimization condition includes at least one of:
a time window;
a traffic threshold; or
a packet error rate.

As shown in FIG. 16, an embodiment of the present disclosure provides an information processing apparatus, including:
a fourth receiving module 410, configured to receive rule information, where the rule information is generated according to UE capability information; where the UE capability information indicates whether a UE supports transfer optimization or initiative selective packet discarding performed by the UPF on service data of the UE.

The information processing apparatus may include a UPF, etc.

For example, the fourth receiving module 410 may be a program module, and the program module may implement the foregoing operations after being executed by the processor.

The fourth receiving module 410 may further include a rigid-flex module; the rigid-flex module includes but is not limited to a programmable circuit; and the programmable circuit includes but is not limited to a field programmable circuit and/or a complex programmable circuit.

In some other embodiments, the fourth receiving module 410 may be a hardware-only module; and the hardware-only module includes but is not limited to an application-specific integrated circuit.

In some embodiments, the information processing apparatus may further include a storage module. The storage module is connected to the third receiving module and is at least configured to store the rule information.

In some embodiments, the fourth receiving module 410 is configured to receive an N4 rule provided by a session management function SMF.

In some embodiments, the apparatus further includes:
a performing module, configured to perform, according to the rule information, transfer optimization or initiative selective packet discarding on service data related to the UE.

In some embodiments, the performing module is configured to: perform the transfer optimization or initiative selective packet discarding on the service data related to the UE according to the rule information, and at least one of: a prediction result provided by a network data analytics function (NWDAF) or the notification of the access network function node.

In some embodiments, the performing module is configured to: perform the transfer optimization or the initiative selective packet discarding on the service data related to the UE in response to determining that at least one of the prediction result provided by the NWDAF or the notification of the access network function node indicates that the service data of the UE meets an optimization condition corresponding to the rule information.

In some embodiments, the performing module is configured to: perform the transfer optimization or initiative selective packet discarding on the service data related to the UE according to the rule information, and at least one of the prediction result provided by the NWDAF or the notification of the access network function node, and an optimization granularity corresponding to the rule information.

An embodiment of the present disclosure provides a communication device, including:
a memory for storing a processor-executable instruction;
a processor, connected to the memory;
where the processor is configured to perform the information processing method provided in any one of the above technical solutions.

The processor may include various types of storage media, the storage media are non-transitory computer storage media, and can continue to memorize information stored on the storage media after the communication device is powered off.

The communication device herein includes UE and/or various network nodes. The network node includes but is not limited to:
The processor may be connected to the memory by using a bus or the like, and is configured to read an executable program stored in the memory, for example, at least one of the methods shown in FIG. 2, FIG. 3A-3C and FIG. 4.

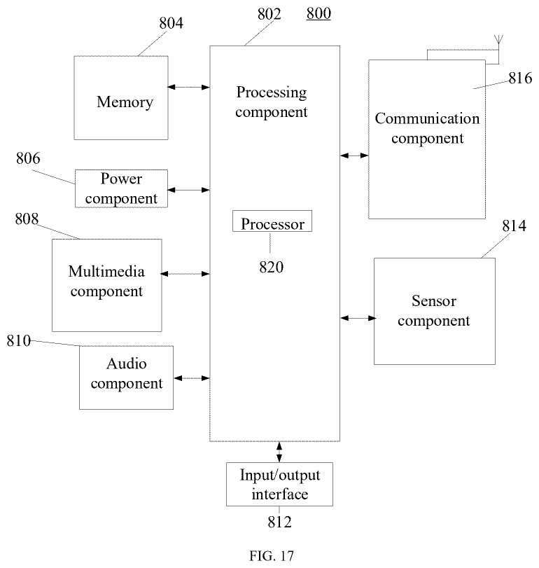

FIG. 17 is a block diagram of a UE 800 according to an example embodiment. For example, the UE 800 may be a mobile phone, a computer, a digital broadcast UE, a messaging device, a game console, a tablet device, a medical device, a fitness device, a personal digital assistant, or the like.

Referring to FIG. 17, the UE 800 may include one or more of: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as operations associated with display, telephone calls, data communications, camera operations, and recording operations. The processing component 802 may include one or more processors 820 to execute instructions to perform all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of such data include instructions for any application or method operating on the UE 800, contact data, phonebook data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power for various components of the UE 800. The power component 806 may include a power management system, one or more power sources, and other components associated with generating, managing, and distributing power for the UE 800.

The multimedia component 808 includes a screen providing an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the UE 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, which may be keyboards, click wheels, buttons, etc. These buttons may include, but are not limited to, home buttons, volume buttons, start buttons, and lock buttons.

The sensor component 814 includes one or more sensors for providing status assessments of various aspects of the UE 800. For example, the sensor component 814 may detect an open/closed status of the UE 800, relative positioning of components, such as a display and a keypad of the UE 800, a change in position of the UE 800 or a component of the UE 800, a presence or absence of user contact with the UE 800, an orientation or acceleration/deceleration of the UE 800, and a change in temperature of the UE 800. The sensor component 814 may include a proximity sensor configured to detect the presence of nearby objects without requiring any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G, or 3G, or a combination thereof. In an example embodiment, the communication component 816 receives a broadcast signal or broadcast related information from an external broadcast management system via a broadcast channel. In an example embodiment, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the above methods.

In an example embodiment, there is further provided a non-transitory computer-readable storage medium including an instruction, such as a memory 804 including the instruction, where the instruction is executable by a processor 820 of the UE 800 to perform the above method. For example, the non-transitory computer-readable storage medium may be a ROM (read-only memory), a RAM (random access memory), CD-ROM (compact disc read-only memory), magnetic tape, floppy disk, optical data storage device, or the like.

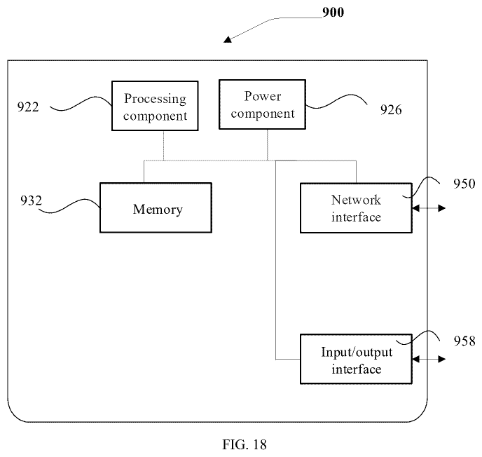

As shown in FIG. 18, an embodiment of the present disclosure shows a structure of an access device. For example, the communication device 900 may be provided as a network-side device. The communication device may include the access network function node, the AMF, the UPF, the SMF, or the PCF.

Referring to FIG. 18, the communication device 900 includes a processing component 922, which further includes one or more processors, and a memory resource represented by a memory 932 for storing instructions executable by the processing component 922, such as an application program. The application program stored in the memory 932 may include one or more modules each corresponding to a set of instructions. In addition, the processing component 922 is configured to execute instructions to perform any method applied to the access device in the above method, for example, the method shown in any one of FIG. 2, FIG. 3A to FIG. 3C, and FIG. 4 to FIG. 11.

The communication device 900 may also include a power component 926 configured to perform power management of the communication device 900, a wired or wireless network interface 950 configured to connect the communication device 900 to a network, and an input/output (I/O) interface 958. The communication device 900 may operate based on an operating system stored in memory 932, such as Windows Server™, Mac OS X™, Unix™, Linux™, FreeBSD™, or the like.

Embodiments of the present disclosure provide a computer storage medium, where the computer storage medium stores an executable program; and after the executable program is executed by a processor, the information processing method provided by any of the foregoing technical solutions can be implemented, for example, the method shown in any one of FIG. 2, FIG. 3A to FIG. 3C, and FIG. 4 to FIG. 11 is performed.

The computer storage medium may include a non-transitory storage medium.

Other embodiments of the present disclosure will easily occur to those skilled in the art after considering the specification and practicing the present disclosure herein. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. A method for information processing performed by a user equipment (UE), the method comprising:
sending UE capability information to an access network function node;
wherein the UE capability information indicates whether the UE supports transfer optimization or initiative selective packet discarding performed by a user plane function (UPF) on service data of the UE.

2. The method according to claim 1, wherein sending the UE capability information to the access network function node comprising at least one of:
sending a registration request message comprising the UE capability information to the access network function node;
sending a registration update message comprising the UE capability information to the access network function node; or
sending a UE configuration update message comprising the UE capability information to the access network function node.

3. The method according to claim 1, wherein the service data comprises:
service data of an extended reality and media (XRM) service or service data of a multimodal service.

4. The method according to claim 1, wherein the UE capability information is carried in a UE mobility management core network (MM CN) capability parameter.

5.-9. (canceled)

10. A method for information processing performed by a policy control function (PCF) or a session management function (SMF), the method comprising:
receiving user equipment (UE) capability information provided by an access management function (AMF), wherein the UE capability information indicates whether a UE supports transfer optimization or initiative selective packet discarding performed by a user plane function (UPF) on service data of the UE.

11. The method according to claim 10, wherein the method further comprises:
generating policy information according to the UE capability information; wherein a rule corresponding to the policy information is used by a user plane function (UPF) to perform transfer optimization or initiative selective packet discarding on service data related to the UE.

12. The method according to claim 11, wherein the policy information comprises at least one of:
an optimization granularity, indicating a quality of service (QoS) flow, a data flow, a protocol data unit (PDU) set, or a data packet on which the transfer optimization or the initiative selective packet discarding is performed by the UPF; or,
an optimization condition, indicating a condition to be met when the UPF performs the transfer optimization or the initiative selective discarding.

13. The method according to claim 12, wherein the optimization condition comprises at least one of:
a time window;
a traffic threshold; or
a packet error rate.

14. A method for information processing performed by a user plane function (UPF), the method comprising:
receiving rule information, wherein the rule information is generated according to UE capability information; wherein the UE capability information indicates whether a UE supports transfer optimization or initiative selective packet discarding performed by the UPF on service data of the UE.

15. The method according to claim 14, wherein receiving the rule information comprises:
receiving a N4 rule provided by a session management function (SMF).

16. The method according to claim 14, wherein the method further comprises:
performing, according to the rule information, transfer optimization or initiative selective packet discarding on service data related to the UE.

17. The method according to claim 16, wherein performing, according to the rule information, the transfer optimization or initiative selective packet discarding on the service data related to the UE comprises:
performing the transfer optimization or initiative selective packet discarding on the service data related to the UE according to the rule information, and at least one of a prediction result provided by a network data analytics function (NWDAF) or a notification of an access network function node.

18. The method according to claim 17, wherein performing the transfer optimization or initiative selective packet discarding on the service data related to the UE according to the rule information, and at least one of: the prediction result provided by the NWDAF or the notification of the access network function node comprises:
performing the transfer optimization or the initiative selective packet discarding on the service data related to the UE in response to determining that at least one of the prediction result provided by the NWDAF or the notification of the access network function node indicates that the service data of the UE meets an optimization condition corresponding to the rule information.

19. The method according to claim 17, wherein performing the transfer optimization or the initiative selective packet discarding on the service data related to the UE indicated by the rule information and at least one of the prediction result provided by the NWDAF or the notification of the access network function node comprises:
performing the transfer optimization or initiative selective packet discarding on the service data related to the UE according to the rule information, and at least one of the prediction result provided by the NWDAF or the notification of the access network function node, and an optimization granularity corresponding to the rule information.

20.-38. (canceled)

39. A communications device, comprising:
a processor,
a transceiver,
a memory that stores an executable program,
wherein the executable program when executed by the processor cause the communication device to act as the UE and perform the method according to claim 1.

40. A non-transitory computer storage medium storing an executable program; the executable program when executed by a processor of the UE, cause the UE to perform the method according to claim 1.

41. A communications device, comprising:
a processor,
a transceiver,
a memory that stores executable program,
wherein the executable program when executed by the processor cause the communication device to act as the PCF or the SMF and perform the method according to claim 10.

42. A communications device, comprising:
a processor,
a transceiver,
a memory that stores an executable program,
wherein the executable program when executed by the processor cause the communication device to act as the UPF and perform the method according to claim 14.

43. A non-transitory computer storage medium storing an executable program; the executable program when executed by a processor of the PCF or the SMF, cause the PCF or the SMF to perform the method according to claim 10.

44. A non-transitory computer storage medium storing an executable program; the executable program when executed by a processor of the UPF, cause the UPF to perform the method according to claim 14.
